(19) United States
(12) Patent Application Publication
(10) Pub. No.: US 2026/0015904 A1
(43) Pub. Date: Jan. 15, 2026

(54) UNIVERSAL FRAME FOR CONCEALED DOORS SUITABLE FOR INWARD AND OUTWARD OPENING CONFIGURATIONS AND RIGHT OR LEFT DOOR SWING

(71) Applicant: Oscar Torrabias Cantal, Barcelona (ES)

(72) Inventor: Oscar Torrabias Cantal, Barcelona (ES)

(21) Appl. No.: 19/075,993

(22) Filed: Mar. 11, 2025

(30) Foreign Application Priority Data
Jul. 9, 2024 (ES) U202431313

(51) Int. Cl. E06B 1/52; E06B 3/964

(52) U.S. Cl. CPC E06B 1/526; E06B 3/9641

(57) ABSTRACT

A frame that addresses the identified technical problems and provides a universal construction system for concealed door frames that can be applied interchangeably to doors opening outward or inward, using only four structural components and without requiring any off-site preparation before installation.

### TECHNICAL FIELD

The present invention pertains to the field of construction components and assemblies, specifically to concealed door frames designed to accommodate various opening configurations without requiring multiple profile models.

### BACKGROUND OF THE INVENTION

In the field of construction and interior design, particularly regarding the installation of frameless doors, also referred to as concealed doors, traditional systems such as those described in patents U.S. Pat. No. 3,001,224 and EP1780357 require precise measurement and custom fabrication of the door frame to fit the door opening where the installation will take place. This allows little room for post-installation adjustments and increases the risk of aesthetic and functional errors.

Specifically, the pre-selection of appropriate frame profile models is necessary to assemble the frame depending on whether the door swings to the right or left and whether it opens inward or outward.

Additionally, it is crucial to determine the weight of the door leaf to establish the required number of hinges needed to support it, as well as the hinge model selected by the installer. This information is essential for machining the appropriate hinge recesses in the frame profile, since each hinge model has a unique recess configuration. These machined recesses must be positioned correctly in the frame so that they align with the factory-prepared hinge recesses in the door leaf.

This results in complex planning and inventory management, as well as high manufacturing and storage costs due to the necessity of multiple door frame profile models and the preliminary preparation of components performed off-site.

To eliminate the need for machining the frame profile to accommodate the hinges-thus reducing the off-site preparation of door components-the frame system described in patent EP3677745A1 was developed. This patent describes a frame made from a specific door frame profile that allows the direct insertion of a hinge specifically designed for this purpose, without machining.

This hinge features a first body with a specific design that allows it to be fixed at any position along the profile, and a second conventional body that fits into a factory-prepared hinge recess in the door leaf. Both hinge bodies are connected through a specially designed articulated joint.

The ability to fix the hinge at any position along the profile makes it easier to align the hinge positions in the frame with the factory-prepared hinge recesses in the door leaf, preventing misalignments due to measurement errors.

For this purpose, the door frame profile includes a differentiated section for wall attachment and another differentiated section for hinge attachment. The shape of these sections varies depending on whether the door opens inward or outward, as illustrated in FIGS. 4 and 6 of document EP3677745A1.

This necessitates the use of multiple door frame profile models depending on the door's opening direction, which presents a significant limitation in terms of operational and economic efficiency, particularly in large-scale construction projects or in cases where specifications may change during the construction process.

Furthermore, the requirement for different door frame profiles to assemble the door frame increases inventory complexity and can lead to errors in selecting the necessary profile for installation.

Another issue arising from the state-of-the-art technology is the inability to use conventional hinges, meaning the installer is restricted to a specific type of hinge, which is not always readily available.

A minor additional problem is that the connection of profile sections at 90-degree angles is achieved by miter-cutting the ends. A miter cut is more complex in terms of measurement and execution compared to a straight cut or transverse cut.

The new universal frame for concealed doors addresses these problems by facilitating door installation and eliminating the need for different profile models depending on the door's swing direction.

At the same time, it allows the installer to use any type and model of concealed hinge available on the market, significantly simplifying logistics and reducing associated costs.

Additionally, it enables the assembly of profile sections with straight cuts, simplifying the measurement process.

### DETAILED DESCRIPTION OF THE INVENTION

The frame described in this invention addresses the identified technical problems and provides a universal construction system for concealed door frames that can be applied interchangeably to doors opening outward or inward, using only four structural components and without requiring any off-site preparation before installation.

The new frame includes:

A single profile with a complex rectangular cross-section, forming the door frame, specifically the two vertical sections and the horizontal section. This profile features a projection located at the end of one of its faces, where the door leaf fits when closed.

A connecting element, which allows the horizontal section of the profile to be joined with the right and left vertical sections without requiring a miter cut, using only a straight cut.

An adapter, which can be inserted at any position along the profile, remaining firmly attached to it, and featuring a seating area where one side of a conventional hinge fits. This adapter can be multipurpose, allowing compatibility with multiple hinge models.

A cover, which attaches to the profile, concealing the open spaces between the adapters where the hinges are seated.

The profile is the base component of the frame assembly. According to the invention, it has a rectangular cross-section with an open face on one of its shorter sides, forming a channel into which the hinge adapters are inserted. These adapters can be freely positioned along the channel, making it easier to align them with the factory-prepared hinge recesses in the door leaf.

The outer walls of the profile feature multiple tooth-shaped ribs, designed to secure the frame to the wall opening using cement or other adhesives, while also providing structural rigidity.

The projection on the profile consists of an integral protrusion with two flat surfaces, extending linearly from the main body of the profile along the edge of one of its faces, running its entire length. This protrusion extends beyond the plane of the open face, obstructing the path of the door leaf as it rotates on the hinges while also serving as a mounting point for additional components.

On the projection surface facing the open face of the profile, the first flat surface is positioned, against which the door leaf rests when closed. This surface ensures continuous and uniform contact between the frame and the door.

A notch is integrated into this first flat surface, designed with a width and depth sufficient to accommodate a sealing strip, usually made of an elastic, wear-resistant material. The sealing strip closes the gap between the door and the frame, improving soundproofing and energy efficiency by preventing air drafts.

The projection of the profile provides structural support around the door leaf, ensuring a solid contact point along all three sections of the frame when the door is closed, enhancing its stability and alignment.

On the projection surface facing outward from the frame, a second flat surface is located, forming an angle between 90° and 135° relative to the first flat surface. When the door is closed, the edge of the door leaf is positioned against this second flat surface, making it visible when the door is open but concealed when closed.

The projection surface facing the main body of the profile includes multiple tooth-shaped ribs, which facilitate attachment to the wall opening using cement or adhesives.

This projection makes the profile asymmetrical, which is the key to its versatility and adaptability to different door configurations.

The profile can be installed with the projection positioned either on the right or left simply by flipping it along its transverse axis, allowing for left- or right-swinging doors as well as inward-or outward-opening doors. This design enables installers to decide the door configuration at the time of installation.

For outward-opening doors, the projection aligns with the inner face of the door leaf.

For inward-opening doors, the projection aligns with the outer face of the door leaf.

This change is achieved simply by flipping the profile, eliminating the need for different profile models, which significantly reduces production and storage costs and simplifies logistics.

The connecting element is designed to join the frame profile sections that form the door frame, specifically the horizontal section with the two vertical sections. Each frame requires two units of the connecting element.

This connecting element has a square prism-shaped structure, where the prism base has a length equal to the height of the frame profile, including the projection. Meanwhile, the shorter side of the rectangular lateral faces corresponds to the width of the frame profile excluding the projection.

One prism base features a square projection at one corner, with a side length matching the projection of the frame profile.

The adjacent lateral faces of the prism, next to the square projection, include a tenon with a cross-section that fits into the channel of the frame profile. This allows the tenon to be inserted into the frame profile channel, securing the connection.

Thus, the frame is assembled by joining the vertical frame profile sections to the horizontal section using two connecting elements. Each tenon is inserted into the side of a frame profile, ensuring that the square projection aligns with the projections of the frame profiles, and only requiring straight cuts at the profile ends, eliminating the complexity of miter cuts.

This method enables a 90-degree joint, where the body of the connecting element extends the main body of the frame profile, and the square projection continues the profile's projection.

For basic installations, the connecting element can be universal and used on either side. However, for more advanced configurations, where maximum sealing strip coverage or rib alignment is required, specific right-side and left-side versions of the connecting element may be preferable.

The adapter is a rectangular block designed to fit into the frame profile channel. Its width and depth match the channel cross-section, while its length is slightly greater than that of the hinge used in the installation.

Once inserted at any position along the frame profile channel, the adapter is firmly secured with two screws fastened into the bottom of the profile.

The adapter includes a seating area designed to accommodate one side of a conventional hinge. It can be multipurpose, allowing compatibility with multiple hinge models.

The cover serves to conceal the visible sections of the frame profile channel, giving the frame an appearance similar to a standard door frame.

The invention significantly simplifies the installation of the concealed door frame. Installers only need to cut three sections of the frame profile to the required length, join them using two connecting elements, and insert the tenons into the square-cut frame profile sections, ensuring the profile channel is oriented toward the inside of the frame and properly positioned according to the door swing direction.

By simplifying profile selection, allowing straight cuts, and enabling versatile door configurations, the invention reduces installation errors, accelerates assembly, and improves efficiency, offering greater design flexibility without compromising structural performance.

### BRIEF DESCRIPTION OF THE DRAWINGS

To illustrate everything described so far, this specification is accompanied by a sheet of drawings depicting an exemplary embodiment of the invention.

In these drawings:

FIG. 1 shows a perspective view of the profile according to the invention.

FIG. 2 shows a perspective view of the cover according to the invention.

FIG. 3 shows a perspective view of the connecting element according to the invention.

FIG. 4 shows a perspective view of the hinge adapter according to the invention.

FIG. 5 shows a cross-sectional view of the profile with the cover mounted.

FIG. 6 shows a perspective view of the profile and cover according to the invention.

FIG. 7 shows an exploded view of the profile and cover according to the invention.

FIG. 8 shows a cross-sectional view of a frame according to the invention with an inward-opening configuration.

FIG. 9 shows a cross-sectional view of a frame according to the invention with an outward-opening configuration.

FIG. 10 shows a schematic view of the universal frame according to the invention with a right-hand door swing and an outward-opening configuration.

FIG. 11 shows a schematic view of the universal frame according to the invention with a left-hand door swing and an inward-opening configuration.

FIG. 12 shows a schematic view of the universal frame according to the invention with a right-hand door swing and an inward-opening configuration.

FIG. 13 shows a schematic view of the universal frame according to the invention with a left-hand door swing and an inward-opening configuration.

FIG. 14 shows an exploded view of the universal frame according to the invention.

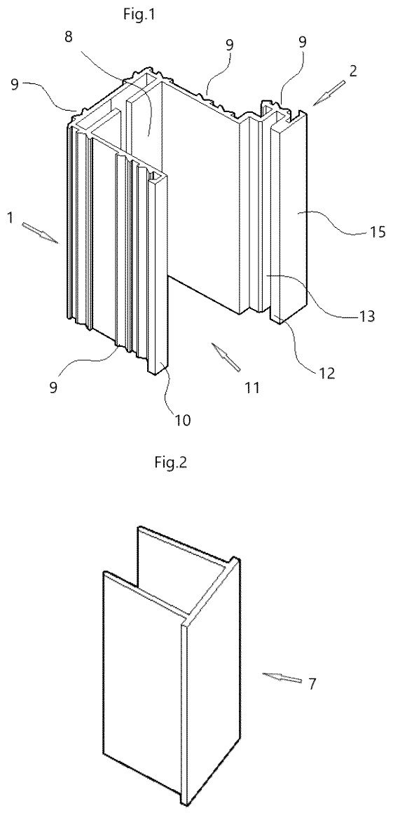

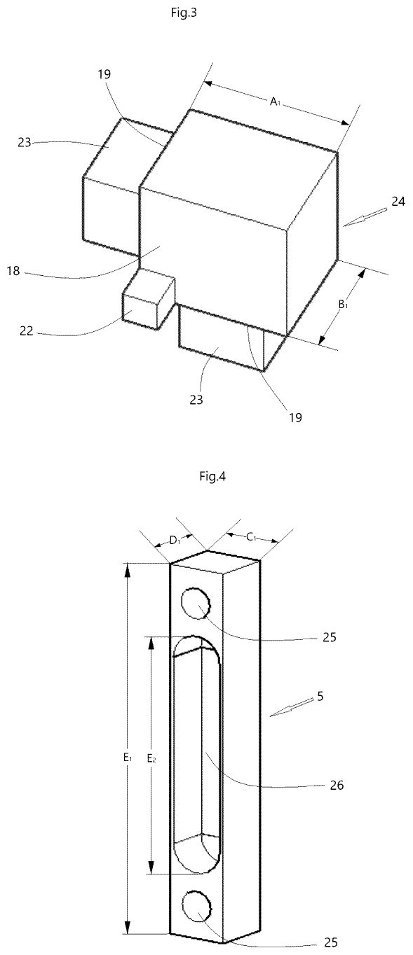

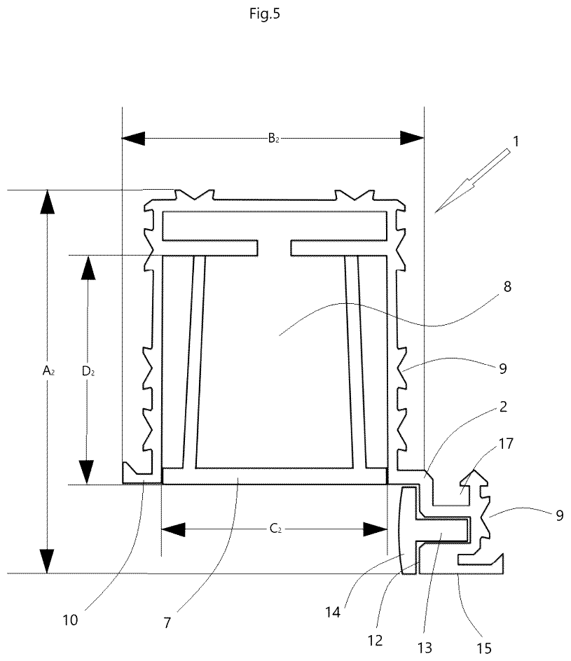

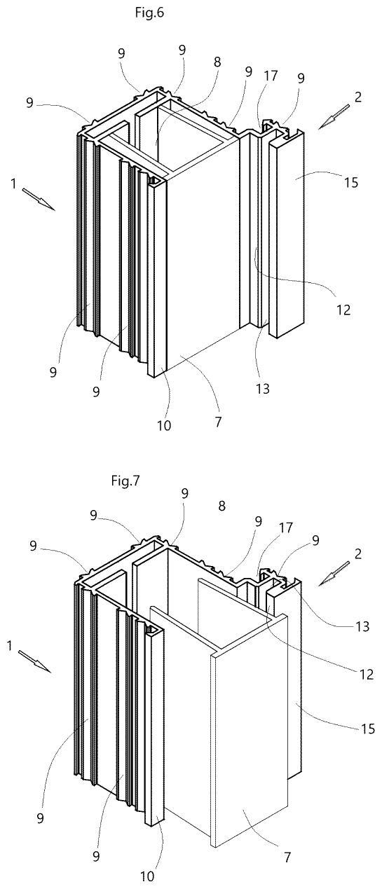

### REFERENCE LIST

1. Frame profile
2. Projection
3. Frame
4. Connecting element
5. Adapter
6. Hinge
7. Cover
8. Channel
9. Tooth-shaped ribs
10. Main body of the frame profile
11. Open face
12. First flat surface
13. Notch
14. Sealing strip
15. Second flat surface
16. Door leaf
17. Projection surface
18. Prism base
19. Lateral faces of the prism
20. Horizontal section of the frame
21. Vertical sections of the frame
22. Square projection
23. Tenon
24. Square prism-shaped body
25. Perforations
26. Seating area

### PREFERRED EMBODIMENT OF THE INVENTION

The example represented corresponds to a simplified version of the invention, in which the frame consists of four structural components:

Three units of a single profile (1) with a complex rectangular cross-section, forming the vertical and horizontal sections of the frame (3) through straight cuts, and featuring a projection (2) at the end of one of its faces.

Two units of the connecting element (4), which assemble the different profile sections that make up the frame (3).

Three units of the adapter (5), which are inserted into the profile (1), each accommodating one side of a conventional hinge (6).

Six sections of the cover (7), which are attached to the profile sections (1), covering the open spaces between the adapters where the hinges are seated.

According to the illustrated example, the profile (1) has a rectangular cross-section with an open face (11) on one of its shorter sides, forming an internal channel (8) where the adapters (5) are inserted, while its outer walls feature tooth-shaped ribs (9).

The projection (2) extends from the main body of the profile (10), beyond the plane of the open face (11), and runs along the edge of one of its faces along its entire length.

Two flat surfaces are distinguished on the projection (2).

The first flat surface (12) faces the open face (11) of the profile (1) and includes a notch (13) designed to hold a sealing strip (14) made of an elastic and wear-resistant material.

The second flat surface (15) faces outward from the frame (3) and forms an angle of approximately 90° to the first flat surface (12).

The edge of the door leaf (16) aligns with the second flat surface (15) when the door is closed.

The projection surface (17) facing the main body of the profile (10) also incorporates tooth-shaped ribs (9).

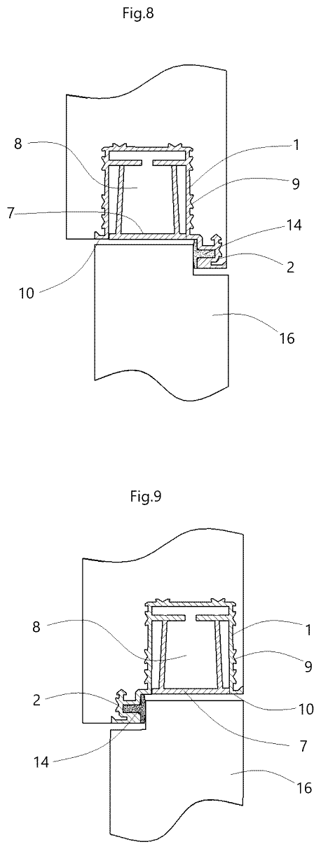

The profile (1) is sectioned into three parts using straight cuts to form the frame and can be positioned with the projection (2) on the right side of the main body of the profile (10), as shown in FIG. 8, or on the left side, as shown in FIG. 9, simply by flipping the section along its transverse axis to invert its position.

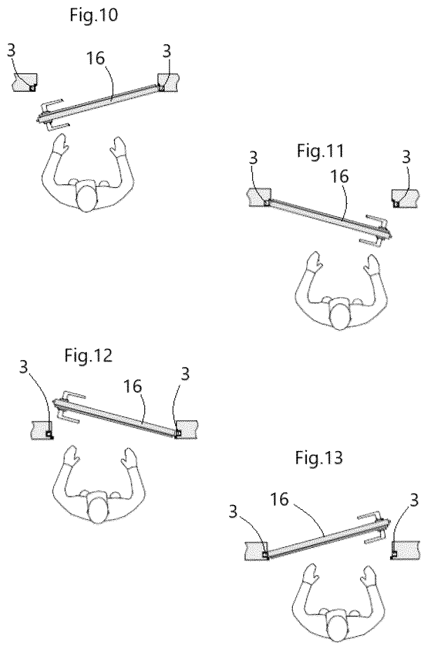

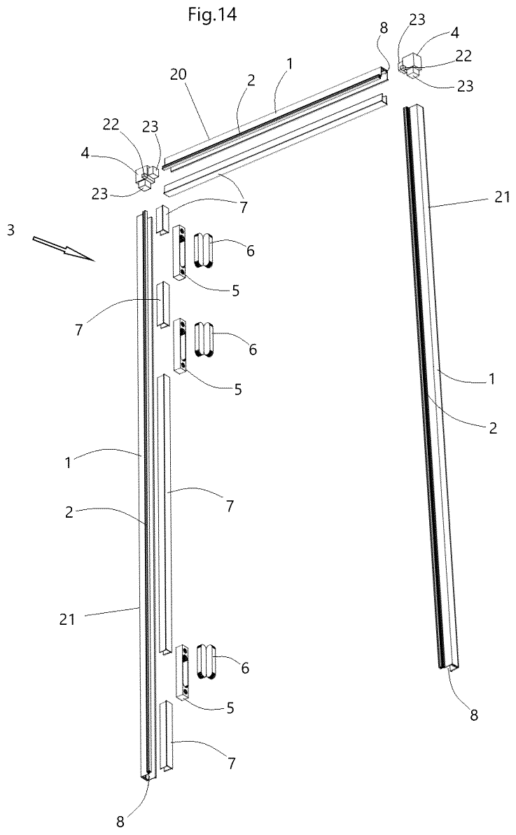

Depending on the chosen profile position, the frame (3) adapts to doors swinging to the left or right and opening inward or outward, as shown in FIGS. 10 to 13.

The connecting element (4) is designed to join the horizontal frame section (20) with the two vertical frame sections (21), forming a 90-degree angle.

According to the illustrated example, the connecting element (4) has a square prism-shaped body (24), where the prism base (18) has a length “A1” equal to the height “A2” of the profile (1), while the shorter side of the prism's lateral faces (19) has a length “B1” equal to the width “B2” of the profile (1).

One of the prism bases (18) features a square projection (22) at one corner, with a side length “C1” matching the length “C2” of the projection (2) of the profile.

The lateral faces of the prism (19) adjacent to the corner where the square projection (22) is located include a tenon (23) with a cross-section that matches the cross-section of the channel (8) of the profile.

The connecting element (4) serves as the junction between the vertical profile sections (21) and the horizontal profile section (20), ensuring that the square prism-shaped body (24) continues the main body of the profile (10), while the square projection (22) aligns with the projection (2).

In advanced versions, the square prism-shaped body extends the main body of the profile, including the ribs, and likewise, the square projection continues the projection.

According to the illustrated example, in the adapter (5), the width “C1” and depth “D1” correspond to the width “C2” and depth “D2” of the channel cross-section (8), while the length “E1” is greater than the length “E2” of the hinge (6).

As shown in the illustrated example, the adapter (5) features two perforations (25) at its ends, allowing fastening screws to secure it to the profile, as well as a seating area (26) where one side of the hinge (6) is inserted.

1. A universal frame for concealed doors, suitable for inward and outward opening configurations and right- or left-hand door swing, the universal frame comprising:
a profile (1) divided into sections by straight cuts having a complex rectangular cross-section with an open face on one of its sides, forming an internal channel (8) along interior walls and having tooth-shaped ribs (9) on exterior walls, the profile includes a projection (2) that extends from a main body of the profile (10) beyond a plane of an open face (11) and runs along edge of one of the sides, wherein the projection includes a first flat surface (12) facing the open face (11) of the profile, with a notch (13) in which a sealing strip (14) is inserted, and a second flat surface (15) facing outward from the frame (3), forming an angle between 90° and 135° relative to the first flat surface (12),
a connecting element (4) for assembling profile sections (1) at a 90-degree angle, comprising a square prism-shaped body (24), wherein the prism base (18) has a length “A1” equivalent to the height “A2” of the profile (1), and the shorter side of the prism's lateral faces (19) has a length “B1” equivalent to the width “B2” of the profile (1), further comprising:
a square projection (22) at one corner of one of the two prism bases (18), with a side length “C1” matching the length “C2” of the projection (2) of the profile,
two tenons (23) located on the lateral faces of the prism (19), adjacent to the corner where the square projection (22) is positioned, with a cross-section matching the cross-section of the profile's channel (8),
an adapter (5) positioned anywhere along the profile channel (8), remaining firmly attached to it, including a rectangular block whose width “C1” and depth “D1” essentially match the width “C2” and depth “D2” of the profile's channel cross-section (8), and whose length “E1” is significantly greater than the length “E2” of the hinge (6) to be used in the installation. The adapter includes a seating area (26) designed to accommodate the side of one or more hinge models (6), a cover (7) that attaches to the profile (1), covering the open face (11) of the profile.

2. The universal frame for concealed doors according to claim 1, wherein the profile (1) has an asymmetrical cross-section, where the projection (2) can be positioned on either the right side or the left side of the main body of the profile (10) by flipping it along its transverse axis.

3. The universal frame for concealed doors according to claim 1, wherein the seating area (26) includes additional inserts to accommodate different hinge models (6).

4. The universal frame for concealed doors according to claim 1, wherein the tenons (23) of the connecting element (4) are inserted into the profile's channel (8) from the sides, positioning the adjacent profile sections at a 90-degree angle, ensuring that the square prism-shaped body (24) extends the main body of the profile (10) and the square projection (22) aligns with the profile's projection (2).

5. The universal frame for concealed doors according to claims 1, wherein at the square prism-shaped body (24) and the square projection (22) feature ribs as a continuation of the tooth-shaped ribs (9) of the profile (1).
